(19) United States
(12) Patent Application Publication
(10) Pub. No.: US 2026/0251756 A1
(43) Pub. Date: Aug. 27, 2026

(54) METEOROLOGICAL PARAMETER-BASED METHOD FOR CORRECTING GROUND-BASED RADAR ATMOSPHERIC PARAMETERS

(71) Applicant: Beijing University of Civil Engineering and Architecture, Beijing (CN)

(72) Inventors: Runjie Wang, Beijing (CN); Haiqian Wu, Beijing (CN); Xianglei Liu, Beijing (CN); Junyu Kang, Beijing (CN); Nurbaht Aychuah, Beijing (CN); Yunxiang Jia, Beijing (CN); Baihui Yu, Beijing (CN)

(21) Appl. No.: 19/432,909

(22) Filed: Dec. 24, 2025

(30) Foreign Application Priority Data
Feb. 24, 2025 (CN) 202510203219.X

(51) Int. Cl. G01S 7/40; G01B 15/06; G01S 13/00; G01S 13/88

(52) U.S. Cl. CPC G01S 7/40; G01B 15/06; G01S 13/006; G01S 13/88

(57) ABSTRACT

A meteorological parameter-based method for correcting ground-based radar atmospheric parameters includes the steps of: determining reference points based on range bins of a ground-based radar, acquiring mercury thermometer temperatures and electronic meteorological data at the reference points, and constructing a temperature correction model; calculating first atmospheric phases from the electronic meteorological data, identifying stable reference points, and obtaining corrected temperatures of the stable reference points using the temperature correction model; constructing a relative humidity correction model based on the corrected temperatures, and obtaining corrected relative humidities; and performing atmospheric compensation using the corrected temperatures and corrected relative humidities, and determining micro-deformation at a target point based on atmospheric compensation results. This method can not only improve the accuracy of the ground-based radar atmospheric parameter correction method to obtain high-precision and reliable micro-deformation data, but also provide good interpretability, with significant implications for structural health monitoring (SHM) of buildings.

### CROSS-REFERENCE TO RELATED APPLICATION

This application claims priority of Chinese Patent Application No. 202510203219.X, filed on Feb. 24, 2025, the entire contents of which are incorporated herein by reference.

### TECHNICAL FIELD

The present disclosure relates to the field of parameter adjustments, and specifically to a meteorological parameter-based method for correcting ground-based radar atmospheric parameters.

### BACKGROUND

Ground-based radar offers advantages such as non-contact operation, high precision, high sampling frequency, and overall dynamic monitoring. This system can achieve real-time observation of actively deforming bodies, thereby effectively addressing the limitations of traditional deformation monitoring techniques in terms of measurement range, monitoring distance, accuracy, and environmental adaptability. With the continuous advancement of ground-based radar in deformation monitoring, its accuracy has been constantly improving. Under nearly constant atmospheric conditions, the observation accuracy can reach the sub-millimeter level.

However, in real-world environments, atmospheric conditions are highly variable. During the propagation of electromagnetic waves through the atmosphere, atmospheric media refract the propagation direction, causing issues such as propagation time delay and bending of the propagation path. These issues lead to atmospheric phase errors, resulting in radar measurement errors that can reach the centimeter level, severely compromising the accuracy of deformation monitoring results. Therefore, performing atmospheric correction is a crucial step to ensure accurate monitoring.

In the present disclosure, temperature data collected by a mercury thermometer serves as a reference to correct data acquired by an electronic weather station, thereby establishing a temperature correction model. Meteorological data from a stable reference point within a monitoring field of view is utilized to establish a relative humidity correction model. Furthermore, atmospheric compensation is performed using the corrected temperature and relative humidity data to calculate micro-deformation at target points of the ground-based radar. To overcome the limitations of existing optimization and adjustment approaches, the present disclosure provides a meteorological parameter-based method for correcting ground-based radar atmospheric parameters. This method can significantly improve the accuracy of atmospheric parameter correction, thereby enhancing the credibility of data collected by the ground-based radar and achieving long-term structural health monitoring (SHM) of buildings.

### SUMMARY

An objective of the present disclosure is to provide a meteorological parameter-based method for correcting ground-based radar atmospheric parameters.

To realize the above objective, the present disclosure is implemented based on the following technical solutions.

The present disclosure includes the steps of:
determining reference points based on range bins of a ground-based radar, and acquiring mercury thermometer temperatures and electronic meteorological data at the reference points, the electronic meteorological data including electronic weather station temperature, relative humidity, and atmospheric pressure;
constructing a temperature correction model using the acquired mercury thermometer temperatures and the electronic meteorological data;
calculating first atmospheric phases from the electronic meteorological data, identifying stable reference points based on the first atmospheric phases, and obtaining corrected temperatures by inputting electronic weather station temperatures at the stable reference points into the temperature correction model;
constructing a relative humidity correction model based on the corrected temperatures, and obtaining corrected relative humidities by inputting relative humidities at the stable reference points into the relative humidity correction model; and
performing atmospheric compensation using the corrected temperatures and the corrected relative humidities, and determining micro-deformation at a target point based on atmospheric compensation results.

Further, the constructing a temperature correction model includes the steps of:
setting a thermal signal-to-noise ratio threshold to screen reflection points for obtaining reference points, and acquiring mercury thermometer temperatures and electronic meteorological data at the reference points;
partitioning temperature data into a training set and a test set, where the temperature data includes a mercury thermometer temperature

$${T}_{i}^{y}$$

and electronic weather station temperatures

$${T}_{i}^{x}$$

with i=1, 2, . . . , n, where n is total number of temperature samples collected;
determining an order m of a temperature correction model according to a Bayesian information criterion (BIC), in which m<n, and constructing an m+1th-order temperature correction model expressed as;

$$f ( {T}_{i}^{x} ) = {α}_{0} + {α}_{1} {T}_{i}^{x} + {{α}_{2} ( {T}_{i}^{x} )}^{2} + … + {{α}_{m} ( {T}_{i}^{x} )}^{m}$$

where

$$f ( {T}_{i}^{x} )$$

denotes a corrected temperature when the electronic weather station temperature is

$${T}_{i}^{x} ;$$

and αᵢ∈{α₀, α₁, α₂, . . . , αₘ} are temperature correction model coefficients;
determining an optimization objective function AIM₁ for the coefficients of the temperature correction model, expressed as:

$${AIM}_{1} = {{\sum }_{i = 1}}^{n} {[ f ( {T}_{i}^{x} ) - {T}_{i}^{y} ]}^{2}$$

fitting the temperature correction model coefficients ai by inputting training set data into the objective function AIM₁; outputting the corresponding temperature correction model coefficients at when AIM₁ is minimized; updating the temperature correction model using ai, and validating the updated temperature correction model using test set data; and outputting the validated temperature correction model.

Further, the identifying stable reference points includes the steps of:
calculating first atmospheric phases from the electronic meteorological data of the reference points, expressed as:

$${Δφ}_{atm}^{1} = \frac{4 π}{λ} \cdot Δ N \cdot r$$

$$N = 0. 2589 \frac{{P}_{t}}{{T}_{t}^{x}} + \frac{1}{{T}_{t}^{x}} \cdot ( 71.7 + \frac{3.744 \times 1 {0}^{5}}{{T}_{t}^{x}} ) \cdot \frac{{RH}_{t}}{100} \cdot {10}^{\frac{7.5 t}{237 \text{.3} + t} + 0.7858}$$

where

$${Δφ}_{atm}^{1}$$

is a first atmospheric phase, λ is a wavelength of an electromagnetic wave emitted by a ground-based radar, r is a monitoring distance from a target point to the radar, N is an atmospheric refractive index within a monitored environment at time t,

$${T}_{t}^{x}$$

is an electronic weather station temperature at time t, Pₜ is an atmospheric pressure at time t, and RHₜ is a relative humidity at time t; and
performing a secondary screening on the reference points based on the first atmospheric phases to obtain stable reference points, with a screening criterion as follows:

$$\vert {Δφ}_{t} - {Δφ}_{atm}^{1} \vert < 2 S$$

where Δφₜ is an interferometric phase corresponding to a phase φₜ acquired by the ground-based radar at time t, and S is an unbiased estimator.

Further, the obtaining corrected relative humidities includes the steps of:
determining a relative humidity correction model expressed as:

$$g ( {RH}_{t} ) = {β}_{0} + {β}_{1} {RH}_{t} + {{β}_{2} ( {RH}_{t} )}^{2}$$

where g(RHₜ) is a corrected relative humidity when the relative humidity at time t is RHₜ; and β₀, β₁, and β₂ are relative humidity correction model coefficients;
calculating a second atmospheric phase based on the corrected temperature, the corrected relative humidity, and the atmospheric pressure, expressed as:

$${Δφ}_{atm}^{2} = {Δφ}_{atm} [ {P}_{t} , f ( {T}_{t} ) ] + {Δφ}_{atm} [ g ( {RH}_{t} ) ]$$

where

$${Δφ}_{atm}^{2}$$

is the second atmospheric phase, λφₐₜₘ[Pₜ, f(Tₜ)] is an atmospheric phase calculated from the atmospheric pressure Pₜ and the corrected temperature f(Tₜ) at time t, and λφₐₜₘ[g(RHₜ)] is an atmospheric phase calculated from the corrected relative humidity g(RHₜ) at time t;
determining an optimization objective function AIM₂ for the relative humidity correction model coefficients, expressed as:

$${AIM}_{2} = {Δφ}_{t} - {Δφ}_{atm} [ {P}_{t} , f ( {T}_{t} ) ] - {Δφ}_{atm} [ g ( {RH}_{t} ) ]$$

continuously optimizing and adjusting the relative humidity correction model coefficients; outputting the corresponding relative humidity correction model coefficients when the objective function AIM₂ is minimized; updating and outputting the relative humidity correction model using the relative humidity correction model coefficients; and obtaining corrected relative humidities by inputting the relative humidities at the stable reference points into the updated relative humidity correction model.

Further, the determining micro-deformation at a target point includes the steps of:
calculating the second atmospheric phase

$${Δφ}_{atm}^{2}$$

based on the corrected temperatures, corrected relative humidities, and atmospheric pressures to perform atmospheric compensation, and determining micro-deformation at a target point of the ground-based radar based on atmospheric compensation results:

$${Δφ}_{corr} = {Δφ}_{t} - {Δφ}_{atm}^{2}$$

$$Δ d = \frac{λ}{4 π} \cdot {Δφ}_{corr}$$

where λφ_{corr} is a differential phase after atmospheric compensation, Δφₜ is the interferometric phase corresponding to the phase φₜ acquired by the ground-based radar at time t,

$${Δφ}_{atm}^{2}$$

is the second atmospheric phase, Δd is the micro-deformation at the target point of the ground-based radar, and λ is the wavelength of the electromagnetic wave emitted by the ground-based radar.

The present disclosure has the following beneficial effects.

The present disclosure provides a meteorological parameter-based method for correcting ground-based radar atmospheric parameters. Compared with the related art, the present disclosure has the following technical effects.

The present disclosure can enhance the accuracy of ground-based radar atmospheric parameter correction through a sequence of steps: reference point determination, temperature correction, stable reference point screening, relative humidity correction, and atmospheric compensation, thereby enhancing the speed of atmospheric parameter correction for the ground-based radar, significantly conserving resources, and improving the efficiency of atmospheric parameter correction. Moreover, the method can effectively reduce measurement errors from electronic sensors, improve the accuracy of temperature and relative humidity readings, and ensure the reliability and precision of humidity data. By effectively performing atmospheric compensation on target point data, high-precision and reliable micro-deformation data can be obtained, which is of great significance for non-contact SHM of buildings.

### BRIEF DESCRIPTION OF THE DRAWINGS

FIG. 1 is a step flowchart of a meteorological parameter-based method for correcting ground-based radar atmospheric parameters according to the present disclosure.

### DETAILED DESCRIPTION

The present disclosure is further described below with reference to specific embodiments. The illustrative embodiments and explanations provided herein are intended to explain the present disclosure, but are not to be construed as limiting the present disclosure.

The present disclosure provides a meteorological parameter-based method for correcting ground-based radar atmospheric parameters.

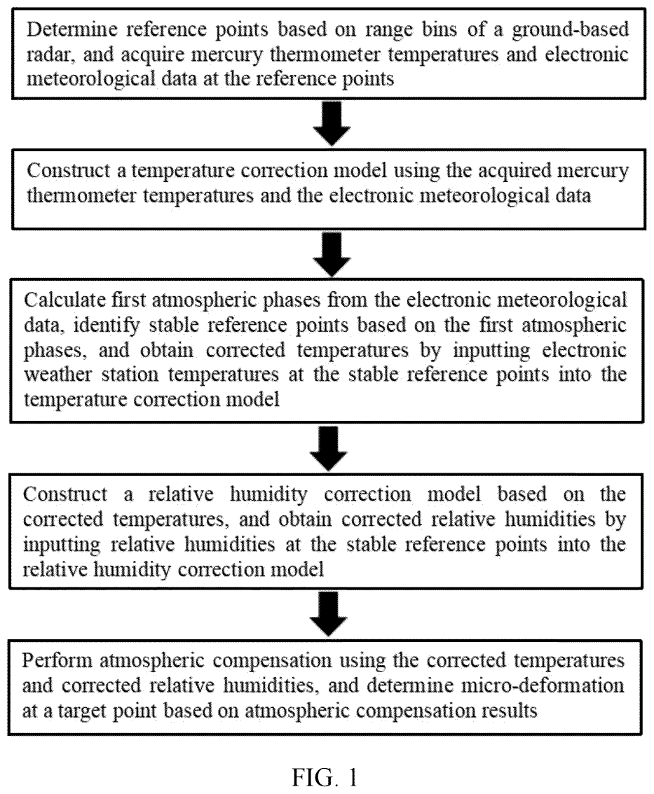

Referring to FIG. 1, in this embodiment, the method includes the following steps:
reference points are determined based on range bins of a ground-based radar, and mercury thermometer temperatures and electronic meteorological data are acquired at the reference points, in which the electronic meteorological data include electronic weather station temperature, relative humidity, and atmospheric pressure;
a temperature correction model is constructed using the acquired mercury thermometer temperatures and the electronic meteorological data;
first atmospheric phases are calculated from the electronic meteorological data, stable reference points are identified based on the first atmospheric phases, and corrected temperatures are obtained by inputting electronic weather station temperatures at the stable reference points into the temperature correction model;
a relative humidity correction model is constructed based on the corrected temperatures, and corrected relative humidities are obtained by inputting relative humidities at the stable reference points into the relative humidity correction model; and
atmospheric compensation is performed using the corrected temperatures and the corrected relative humidities, and micro-deformation at a target point is determined based on atmospheric compensation results.

In this embodiment, a temperature correction model being constructed includes the following steps:
a thermal signal-to-noise ratio threshold is set to screen reflection points for obtaining reference points, and mercury thermometer temperatures and electronic meteorological data are acquired at the reference points;
temperature data is partitioned into a training set and a test set, in which the temperature data includes a mercury thermometer temperature

$${T}_{i}^{y}$$

and electronic weather station temperatures

$${T}_{i}^{x}$$

with i=1, 2, . . . , n, where n is total number of temperature samples collected;
an order m of a temperature correction model is determined according to a BIC, in which m<n, and an m+1 th-order temperature correction model is constructed, expressed as:

$$f ( {T}_{i}^{x} ) = {α}_{0} + {α}_{1} {T}_{i}^{x} + {{α}_{2} ( {T}_{i}^{x} )}^{2} + … + {{α}_{m} ( {T}_{i}^{x} )}^{m}$$

where

$$f ( {T}_{i}^{x} )$$

denotes a corrected temperature when the electronic weather station temperature is

$${T}_{i}^{x} ;$$

and αᵢ∈{, (α₀, α₁, α₂, . . . , αₘ} are temperature correction model coefficients;
an optimization objective function AIM₁ is determined for the coefficients of the temperature correction model, expressed as:

$${AIM}_{1} = {\sum }_{i = 1}^{n} {[ f ( {T}_{i}^{x} ) - {T}_{i}^{y} ]}^{2}$$

the temperature correction model coefficients ai are fitted by inputting training set data into the objective function AIM₁; the corresponding temperature correction model coefficients ai are output when AIM₁ is minimized; the temperature correction model is updated using ai, and the updated temperature correction model is validated using test set data; and the validated temperature correction model is output.

In an actual evaluation, using deformation monitoring of a building structure in a certain area as an example, reflection points with a thermal signal-to-noise ratio greater than 30 dB are selected as reference points, resulting in 10 reference points after screening. The mercury thermometer temperatures and electronic meteorological data (mercury thermometer temperature/° C., electronic weather station temperature/° C., relative humidity/%, atmospheric pressure/hPa) at a specific time for these reference points are obtained as follows: (20.1, 20.5, 40, 1010); (20.3, 20.6, 42, 1008); (20.2, 20.4, 41, 1009); (20.4, 20.7, 43, 1011); (20.0, 20.4, 40, 1010); (20.3, 20.5, 42, 1009); (20.2, 20.4, 40, 1010); (20.4, 20.6, 43, 1012); (20.1, 20.4, 38, 1008); and (20.3, 20.5, 41, 1011).

The order of the temperature correction model is determined as 2 according to the BIC, a third-order temperature correction model is constructed, and the optimized coefficients α₀=0.2, α₁=0.9, and α₂=0.005 are obtained through training with the collected data.

In this embodiment, stable reference points being identified includes the following steps:
first atmospheric phases are calculated from the electronic meteorological data of the reference points, expressed as:

$${Δφ}_{atm}^{1} = \frac{4 π}{λ} \cdot Δ N \cdot r$$

$$N = 0. 2589 \frac{{P}_{t}}{{T}_{t}^{x}} + \frac{1}{{T}_{t}^{x}} \cdot ( 71.7 + \frac{3.744 \times 1 {0}^{5}}{{T}_{t}^{x}} ) \cdot \frac{{RH}_{t}}{100} \cdot {10}^{\frac{7.5 t}{237 \text{.3} + t} + 0.7858}$$

where

$${Δφ}_{atm}^{1}$$

is a mist atmosperic phase, λ is a wavelength of an electromagnetic wave emitted by a ground-based radar, r is a monitoring distance from a target point to the radar, N is an atmospheric refractive index within a monitored environment at time t,

$${T}_{t}^{x}$$

is an electronic weather station temperature at time t, Pₜ is an atmospheric pressure at time t, and RHₜ is a relative humidity at time t; and
a secondary screening is performed on the reference points based on the first atmospheric phases to obtain stable reference points, with a screening criterion as follows:

$$\vert {Δφ}_{t} - {Δφ}_{atm}^{1} \vert < 2 S$$

where Δφₜ is an interferometric phase corresponding to a phase φₜ acquired by the ground-based radar at time t, and S is an unbiased estimator.

In an actual evaluation, the monitoring distance of the ground-based radar is 100 m, and the wavelength of the electromagnetic wave emitted by the radar is 0.1 m. Based on the electronic meteorological data from the reference points, the first atmospheric phases for the 10 reference points are calculated as follows: 6283.2, 6350.1, 6300.5, 6400.3, 6250.2, 6320.6, 6280.4, 6450.7, 6230.8, and 6380.5 (unit: rad). The interferometric phases corresponding to the phases pt acquired by the ground-based radar for the 10 reference points are: 6283.3, 6350.7, 6300.7, 6401.2, 6250.4, 6321.4, 6280.7, 6451.3, 6231.6, and 6381.7 (unit: rad). Under the condition of a high signal-to-noise ratio, defined as a thermal signal-to-noise ratio greater than 30 dB, and with an unbiased estimator set to 0.2 rad, a secondary screening is performed on the reference points based on the first atmospheric phases to identify the 1st, 3rd, 5th, and 7th reference points as the stable reference points.

In this embodiment, corrected relative humidities being obtained includes the following steps:
a relative humidity correction model is determined, expressed as:

$$g ( {RH}_{t} ) = {β}_{0} + {β}_{1} {RH}_{t} + {{β}_{2} ( {RH}_{t} )}^{2}$$

where g(RHₜ) is a corrected relative humidity when the relative humidity at time t is RHₜ; and β₀, β₁, and β₂ are relative humidity correction model coefficients;
a second atmospheric phase is calculated based on the corrected temperature, the corrected relative humidity, and the atmospheric pressure, expressed as:

$${Δφ}_{atm}^{2} = {Δφ}_{atm} [ {P}_{t} , f ( {T}_{t} ) ] + {Δφ}_{atm} [ g ( {RH}_{t} ) ]$$

where

$${Δφ}_{atm}^{2}$$

is the second atmospheric phase, Δφₐₜₘ[Pₜ, f(Tₜ)] is an atmospheric phase calculated from the atmospheric pressure Pₜ and the corrected temperature f(Tₜ) at time t, and λφₐₜₘ[g(RHₜ)] is an atmospheric phase calculated from the corrected relative humidity g(RHₜ) at time t;
an optimization objective function AIM₂ is determined for the relative humidity correction model coefficients, expressed as:

$${AIM}_{2} = {Δφ}_{t} - {Δφ}_{atm} [ {P}_{t} , f ( {T}_{t} ) ] - {Δφ}_{atm} [ g ( {RH}_{t} ) ]$$

the relative humidity correction model coefficients are continuously optimized and adjusted; the corresponding relative humidity correction model coefficients are output when the objective function AIM₂ is minimized; the relative humidity correction model is updated and output using the relative humidity correction model coefficients; and corrected relative humidities are obtained by inputting the relative humidities at the stable reference points into the updated relative humidity correction model.

In an actual evaluation, the electronic weather station temperatures at the reference points 1, 3, 5, and 7 are input into the temperature correction model, obtaining corrected temperatures of 20.3, 20.4, 20.2, and 20.4 (unit: ° C.). Based on these corrected temperatures, along with relative humidity and atmospheric pressure, the humidity correction model coefficients are optimized to β₀=10, β₁=0.9, and β₂=−0.003. Subsequently, the relative humidities at the reference points 1, 3, 5, and 7 are input into the humidity correction model, resulting in corrected relative humidities of 41.2%, 41.9%, 40.5%, and 41.2%.

In this embodiment, micro-deformation being determined at a target point includes the following steps:
the second atmospheric phase

$${Δφ}_{atm}^{2}$$

is calculated based on the corrected temperatures, corrected relative humidities, and atmospheric pressures to perform atmospheric compensation, and micro-deformation is determined at a target point of the ground-based radar based on atmospheric compensation results:

$${Δφ}_{corr} = {Δφ}_{t} - {Δφ}_{atm}^{2}$$

$$Δ d = \frac{λ}{4 π} \cdot {Δφ}_{corr}$$

where λφ_{corr} is a differential phase after atmospheric compensation, Δφₜ is the interferometric phase corresponding to the phase φₜ acquired by the ground-based radar at time t,

$${Δφ}_{atm}^{2}$$

is the second atmospheric phase, Δd is the micro-deformation at the target point of the ground-based radar, and λ is the wavelength of the electromagnetic wave emitted by the ground-based radar.

In an actual evaluation, a monitoring target point is selected. The obtained electronic meteorological data for the target point are 20.3° C., 40.2%, and 1010 hPa. After correction by the temperature correction model and the humidity correction model, the meteorological data are 20.5° C., 41.3%, and 1010 hPa. The calculated second atmospheric phase is 6280.5 rad, and the interferometric phase corresponding to the phase acquired by the ground-based radar is 6280.55 rad. The differential phase after atmospheric compensation is calculated to be 0.5 rad. Based on the atmospheric compensation results, the micro-deformation at the target point of the ground-based radar is calculated to be 0.01963495 mm.

The foregoing is only the preferred embodiment of the present disclosure, rather than limiting the present disclosure. Any modification, equivalent substitution, improvement, and the like made within the spirit and principles of the present disclosure are included within the scope of protection of the present disclosure.

1. A meteorological parameter-based method for correcting ground-based radar atmospheric parameters, comprising the steps of:
S1, determining reference points based on range bins of a ground-based radar, and acquiring mercury thermometer temperatures and electronic meteorological data at the reference points, the electronic meteorological data comprising electronic weather station temperature, relative humidity, and atmospheric pressure;
S2, constructing a temperature correction model using the acquired mercury thermometer temperatures and the electronic meteorological data;
S3, calculating first atmospheric phases from the electronic meteorological data, identifying stable reference points based on the first atmospheric phases, and obtaining corrected temperatures by inputting electronic weather station temperatures at the stable reference points into the temperature correction model;
S4, constructing a relative humidity correction model based on the corrected temperatures, and obtaining corrected relative humidities by inputting relative humidities at the stable reference points into the relative humidity correction model; and
S5, performing atmospheric compensation using the corrected temperatures and corrected relative humidities, and determining micro-deformation at a target point based on atmospheric compensation results.

2. The meteorological parameter-based method for correcting ground-based radar atmospheric parameters according to claim 1, wherein the constructing a temperature correction model comprises the steps of:
setting a thermal signal-to-noise ratio threshold to screen reflection points for obtaining reference points, and acquiring mercury thermometer temperatures and electronic meteorological data at the reference points;
partitioning temperature data into a training set and a test set, wherein the temperature data comprises a mercury thermometer temperature
$${T}_{i}^{y}$$
and electronic weather station temperatures
$${T}_{i}^{x}$$
with i=1, 2, . . . , n, where n is total number of temperature samples collected;
determining an order m of a temperature correction model according to a Bayesian information criterion (BIC), wherein m<n, and constructing an m+1th-order temperature correction model, expressed as:
$$f ( {T}_{i}^{x} ) = {α}_{0} + {α}_{1} {T}_{i}^{x} + {{α}_{2} ( {T}_{i}^{x} )}^{2} + … + {{α}_{m} ( {T}_{i}^{x} )}^{m}$$
where
$$f ( {T}_{i}^{x} )$$
denotes a corrected temperature when the electronic weather station temperature is
$${T}_{i}^{x} ;$$
and αᵢ∈={α₀, α₁, α₂, . . . , αₘ} are temperature correction model coefficients;
determining an optimization objective function AIM₁ for the coefficients of the temperature correction model, expressed as:
$${AIM}_{1} = {\sum }_{i = 1}^{n} {[ f ( {T}_{i}^{x} ) - {T}_{i}^{y} ]}^{2} ;$$
and
fitting the temperature correction model coefficients αᵢ by inputting training set data into the objective function AIM₁; outputting the corresponding temperature correction model coefficients αᵢ when AIM₁ is minimized; updating the temperature correction model using αᵢ, and validating the updated temperature correction model using test set data; and outputting the validated temperature correction model.

3. The meteorological parameter-based method for correcting ground-based radar atmospheric parameters according to claim 1, wherein the identifying stable reference points comprises the steps of:
calculating first atmospheric phases from the electronic meteorological data of the reference points, expressed as:
$${Δφ}_{atm}^{1} = \frac{4 π}{λ} \cdot Δ N \cdot r$$
$$N = 0. 2589 \frac{{P}_{t}}{{T}_{t}^{x}} + \frac{1}{{T}_{t}^{x}} \cdot ( 71.7 + \frac{3.744 \times 1 {0}^{5}}{{T}_{t}^{x}} ) \cdot \frac{{RH}_{t}}{100} \cdot {10}^{\frac{7.5 t}{237 \text{.3} + t} + 0.7858}$$
where
$${Δφ}_{atm}^{1}$$
is a first atmospheric phase, λ is a wavelength of an electromagnetic wave emitted by a ground-based radar, r is a monitoring distance from a target point to the radar, N is an atmospheric refractive index within a monitored environment at time t,
$${T}_{t}^{x}$$
is an electronic weather station temperature at time t, Pₜ is an atmospheric pressure at time t, and RHₜ is a relative humidity at time t; and
performing a secondary screening on the reference points based on the first atmospheric phases to obtain stable reference points, with a screening criterion as follows:
$$\vert {Δφ}_{t} - {Δφ}_{atm}^{1} \vert < 2 S$$
where Δφₜ is an interferometric phase corresponding to a phase φₜ acquired by the ground-based radar at time t, and S is an unbiased estimator.

4. The meteorological parameter-based method for correcting ground-based radar atmospheric parameters according to claim 3, wherein the obtaining corrected relative humidities comprises the steps of:
determining a relative humidity correction model expressed as:
$$g ( {RH}_{t} ) = {β}_{0} + {β}_{1} {RH}_{t} + {{β}_{2} ( {RH}_{t} )}^{2}$$
where g(RHₜ) is a corrected relative humidity when the relative humidity at time t is RHₜ; and β₀, β₁, and β₂ are relative humidity correction model coefficients;
calculating a second atmospheric phase based on the corrected temperature, the corrected relative humidity, and the atmospheric pressure, expressed as:
$${Δφ}_{atm}^{2} = {Δφ}_{atm} [ {P}_{t} , f ( {T}_{t} ) ] + {Δφ}_{atm} [ g ( {RH}_{t} ) ]$$
where
$${Δφ}_{atm}^{2}$$
is the second atmospheric phase, λφₐₜₘ[Pₜ, f(Tₜ)] is an atmospheric phase calculated from the atmospheric pressure Pₜ and the corrected temperature f(Tₜ) at time t, and Δφₐₜₘ[g(RHₜ)] is an atmospheric phase calculated from the corrected relative humidity g(RHₜ) at time t;
determining an optimization objective function AIM₂ for the relative humidity correction model coefficients, expressed as:
$${AIM}_{2} = {Δφ}_{t} - {Δφ}_{atm} [ {P}_{t} , f ( {T}_{t} ) ] - {Δφ}_{atm} [ g ( {RH}_{t} ) ] ;$$
and
continuously optimizing and adjusting the relative humidity correction model coefficients; outputting the corresponding relative humidity correction model coefficients when the objective function AIM₂ is minimized; updating and outputting the relative humidity correction model using the relative humidity correction model coefficients; and obtaining corrected relative humidities by inputting the relative humidities at the stable reference points into the updated relative humidity correction model.

5. The meteorological parameter-based method for correcting ground-based radar atmospheric parameters according to claim 1, wherein the determining micro-deformation at a target point comprises the steps of:
calculating the second atmospheric phase
$${Δφ}_{atm}^{2}$$
based on the corrected temperatures, corrected relative humidities, and atmospheric pressures to perform atmospheric compensation, and determining micro-deformation at a target point of the ground-based radar based on atmospheric compensation results:
$${Δφ}_{corr} = {Δφ}_{t} - {Δφ}_{atm}^{2}$$
$$Δ d = \frac{λ}{4 π} \cdot {Δφ}_{corr}$$
where Δφ_{corr} is a differential phase after atmospheric compensation, Δφₜ is the interferometric phase corresponding to the phase φₜ acquired by the ground-based radar at time t,
$${Δφ}_{atm}^{2}$$
is the second atmospheric phase, Δd is the micro-deformation at the target point of the ground-based radar, and λ is the wavelength of the electromagnetic wave emitted by the ground-based radar.
